(19) United States
(12) Patent Application Publication
(10) Pub. No.: US 2005/0146502 A1
(43) Pub. Date: Jul. 7, 2005

(54) Computer mouse with liquid ornaments

(76) Inventor: Hua Wen Hsu, Taipei (TW)

Correspondence Address: Keith Kline;PRO-TECHTOR INTERNATIONAL SERVICES, 20775 Norada Court, Saratoga, CA, 95070-3018, US

(21) Appl. No.: 10/752,047

(22) Filed: Jan. 5, 2004

(51) Int. Cl. G09G 5/08

(52) U.S. Cl. 345/163

(57) ABSTRACT

A computer mouse with liquid ornaments is comprised of a main body of mouse and an ornament disposed on the main body, in which the ornament may contain a mere liquid or a floating-article-contained liquid. When the main body is under operation, the liquid and floating article will flow or drift to present a sightly vision to heighten people's interest and delight in operating the mouse. Moreover, the ornament is replaceable depending on personal favor.

### BACKGROUND OF THE INVENTION

1. Field of the Invention

This invention relates generally to the structure of a computer mouse, specifically to a computer mouse with detachable liquid ornaments.

2. The Prior Arts

A computer mouse is one of the peripherals of computer used for controlling a cursor on screen, and furthermore, for executing a graphic file or choosing options.

For the sake of attracting consumers, some makers endeavored in adding wheels to a conventional computer mouse for making operation easily, some others engaged in introducing an optical mouse to substitute for that of a roller style cursor-control manner in order to avoid bringing the dust of a slide pad or desktop into the mouse, yet some others made efforts in wireless design of mouse for releasing the bondage of conventional wire-transmission. Nevertheless, however, all the mentioned computer mice work on the basis of the same principle for cursor control in the way a conventional mouse used to do.

For making a conventional computer mouse look more active in configuration, a liquid ornament is added to the tail end of mouse as disclosed recently in U.S. Pat. No. 6,380,926B1—“Computer mouse” and Taiwan patent No. 542380—“Mouse housing with liquid ornament”. However, in either patent, the added liquid ornament is inseparably fixed or glued to the main body of the computer mouse, hence, processing is rather difficult and replacement of the ornament is impossible.

### SUMMARY OF THE INVENTION

For dissolving abovementioned defects, the primary object of this invention is to provide a computer mouse with detachable liquid ornaments, in which the ornaments could be dismounted easily to hence facilitate updating of the printed pattern on the mouse, whenever desired.

In order to realize the foregoing object, the computer mouse with liquid ornaments is comprised of a main body of mouse and an ornament connectively mounted on the main body, in which the bottom end of the main body is a base, on which an inner casing is arranged. A junction area is arranged on two sides of the inner casing and along an edge of the base for connectively mounting the ornament, where a positioning portion is formed on a wall of the edge of the base in the junction area. An assembling space for accommodating the ornament is reserved between the rear end of the inner casing and the base, and the ornament is composed of a casing and a bottom cover, in which a roof portion, which is formed at the front end of the casing for covering on the inner casing, is provided on two sides with a connecting portion for connectively mounting the roof portion to the positioning portion. The roof portion abuts upon a sealing space, which allows a liquid and/or a floating article to enter through an entrance and sealed by the bottom cover. A through hole penetrating through the base is disposed in the bottom end of the base and in the assembling space, and a plurality of connecting portions is provided to the inner wall of the through hole for connectively combining with the ornament. The bottom cover is provided with a protruding portion on a lateral face thereof to be sleeve-jointed with the through hole, in which a positioning portion is further provided to the protruding portion for connectively combining with the connecting portions to thereby facilitate mounting or dismounting the ornament on or from the main body of mouse.

For more detailed information regarding advantages or features of this invention, at least an example of preferred embodiment will be described below with reference to the annexed drawings.

### BRIEF DESCRIPTION OF THE DRAWINGS

The related drawings in connection with the detailed description of this invention to be made later are described briefly as follows, in which:

FIG. 1 is a schematic three-dimensional view of appearance of a computer mouse with liquid ornament of this invention;

FIG. 2-1 is a schematic exploded view of FIG. 1;

FIG. 2-2 is a schematic partially enlarged view of FIG. 2-1;

FIG. 3 is a cutaway sectional view taken along line A-A in FIG. 1;

FIG. 4 is a cutaway sectional view taken along line B-B in FIG. 1;

FIG. 5 is a schematic view showing an embodiment of this invention; and

FIG. 6 is a schematic view showing another embodiment of this invention.

### DETAILED DESCRIPTION OF THE PREFERRED EMBODIMENT

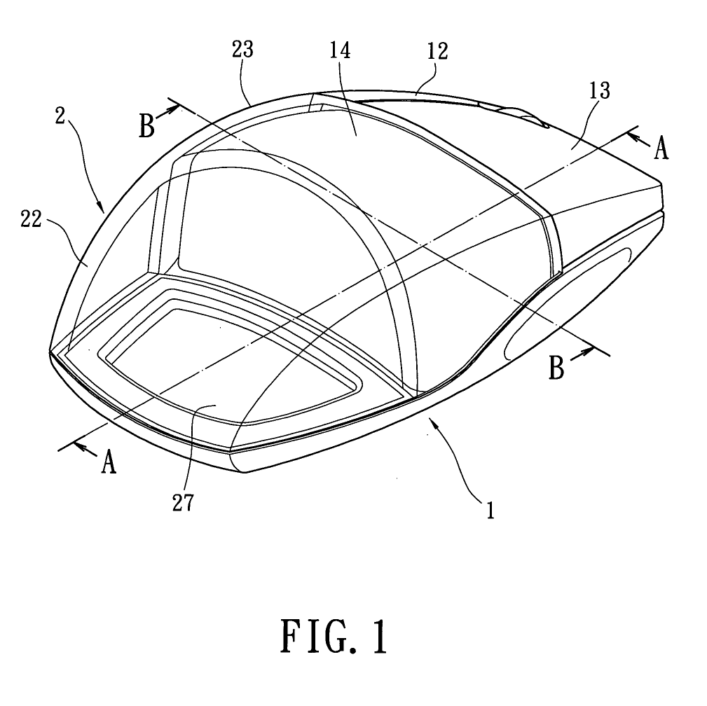

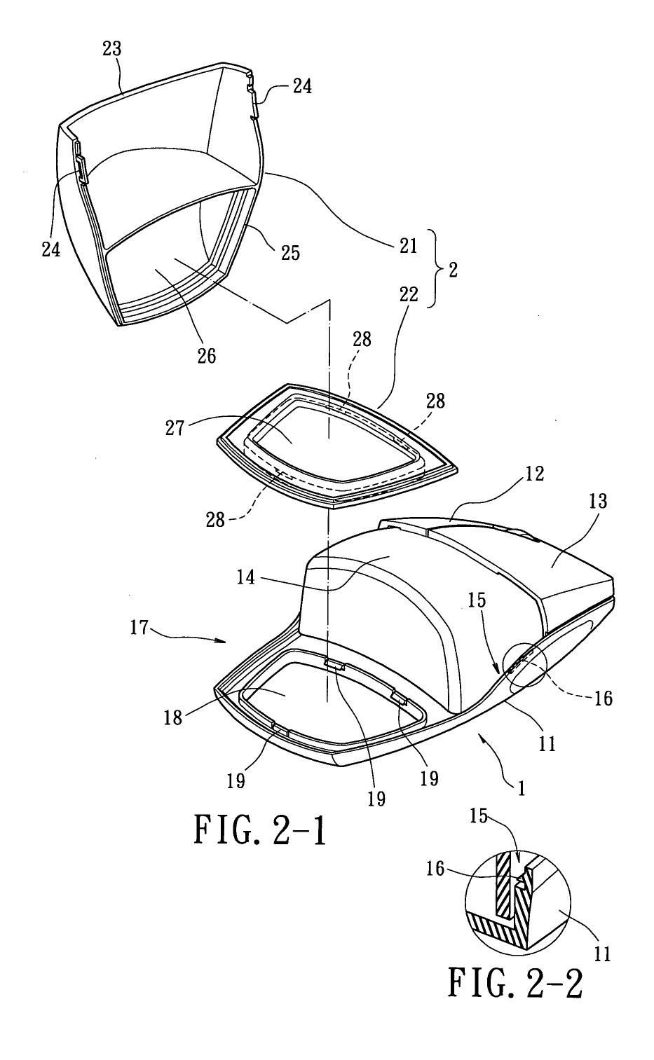

FIG. 1 is a schematic three-dimensional view of appearance of a computer mouse with detachable liquid ornaments of this invention, while FIG. 2-1 and FIG. 2-2 are schematic exploded and partially enlarged views respectively of FIG. 1. As shown in figures, the computer mouse with liquid ornaments of this invention is comprised of a main body 1 of mouse and an ornament 2, in which the ornament 2 is a liquid-contained ornament to be mounted on the main body 1 for promoting image of the computer mouse, interest of using it, and easiness of replacement.

The bottom end of the main body 1 is a base 11, on which a pair of symmetrical keys 12,13 is disposed. In the space between the keys 12,13 and the base 11, an inner casing 14 is arranged, and in the space between the inner casing 14 and the base 11, a circuit board (not shown) for processing operation signals of the main body 1 is inserted. Moreover, a junction area 15 is arranged on two sides of the inner casing 14 and along an edge of the base 11 for connectively mounting the ornament 2, where a positioning portion 16 is formed on a wall of the edge of the base 11 in the junction area 15. Besides, an assembling space 17 for accommodating the ornament 2 is reserved between the rear end of the inner casing 14 and the base 11, in which a through hole 18 penetrating through the base 11 is disposed in the bottom end of the base 11 and in the assembling space 17. A plurality of connecting portions 19 is provided to the inner wall of the through hole 18 for connectively combining with the ornament 2.

The ornament 2 is made of a transparent plastic material, and comprises a casing 21 and a bottom cover 22. A roof portion 23, which is formed at the front end of the casing 21 for covering on the inner casing 14, is provided on two sides with a connecting portion 24 for connectively mounting the roof portion 23 to the positioning portion 16. The roof portion 23 abuts upon a sealing space 25, which allows a liquid and/or a floating article to enter through an entrance 26 to be sealed by the bottom cover 22. The bottom cover 22 has a protruding portion 27 on a lateral face thereof to be sleeve-jointed with the through hole 18, in which a positioning portion 28 is further provided to the protruding portion 27 for connectively combining with the connecting portions 19 to thereby mount or dismount the ornament 2 on or from the main body 1 of mouse.

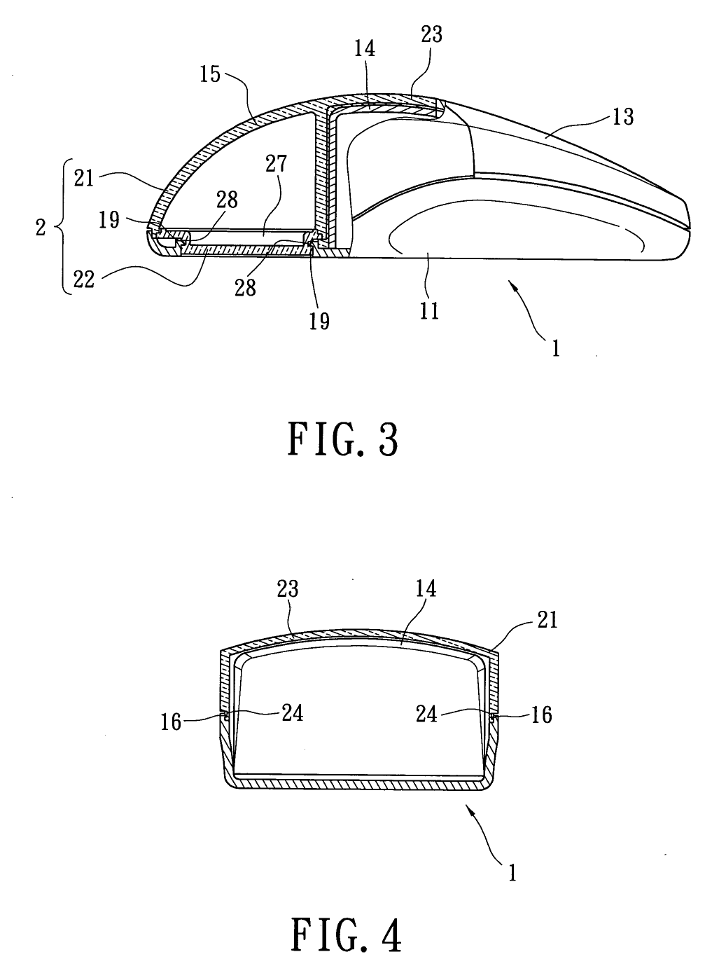

Please refer this time to FIGS. 3 and 4, in which FIG. 3 is a cutaway sectional view taken along line A-A in FIG. 1; and FIG. 4 is a cutaway sectional view taken along line B-B in the same figure. As shown in the figures, a liquid or a floating-article-contained liquid is poured into the sealing space 25 in the casing 21 of the ornament 2, then, the entrance 26 is sealed with the bottom cover 22.

After the liquid and the floating article are retained inside the ornament 2, by means of connectively combining the connecting portion 24 and the positioning portion 28 of the ornament 2 with the positioning portion 16 and the connecting portion 19 of the main body 1, the ornament 2 can be assembled on or disassembled from the main body 1 of mouse, and it is possible for a user to replace the ornament 2 in different patterns.

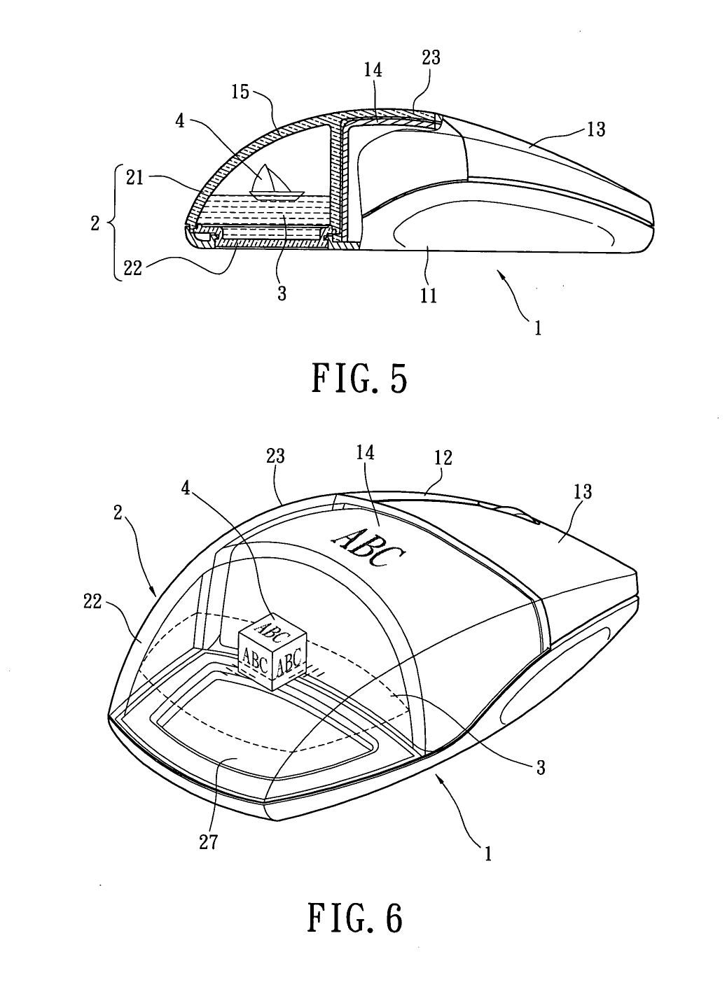

FIG. 5 is a schematic view showing an embodiment of this invention. As shown in FIG. 5, a liquid 3 to be poured into the ornament 2 of this invention could be a liquid of single species or two species indissoluble to each other, while a floating article 4 floated on the liquid 3 could be a three-dimensional pattern in diversified configurations. When a user is operating the main body 1 of mouse, the liquid 3 inside the ornament 2 will flow subsequently, and so does the floating article 4 therein accordingly.

FIG. 6 is a schematic view showing another embodiment of this invention. As indicated in FIG. 6, various patterns, such as trademarks, could be printed or stuck on the surface of the inner casing 14 of the main body 1 and protected by the roof portion 23 at the front end of the casing 21 of the ornament 2 against scratch, etc. Also, the floating article 4 may be made in form of a three-dimensional pattern of trademark as a free gift to be drifted on the liquid 3 in a commercial event.

In addition to the merit of this invention for easy mounting or dismounting the detachable ornament 2 on or from the main body 1 of mouse, a user may replace it by himself without difficulty, and it is very convenient for people to print a trademark and stick it onto the ornament 2.

In the above described, at least one preferred embodiment has been described in detail with reference to the drawings annexed, and it is apparent that numerous changes or modifications may be made without departing from the true spirit and scope thereof, as set forth in the claims below.

1. A computer mouse with detachable liquid ornaments, comprising:
a main body having a base; said base having an inner casing; a junction area arranged on two sides of said inner casing; a positioning portion formed on a wall of an edge of the base in said junction area; an assembling space for accommodating the ornament being reserved between a rear end of said inner casing and said base; a through hole penetrating through the base being formed in the bottom end of said base and in said assembling space; and a plurality of connecting portions provided to the inner wall of said through hole; and
an ornament composed of a casing and a bottom cover, in which a roof portion, which is formed at the front end of the casing for covering on said inner casing, is provided on two sides with a connecting portion for connectively mounting the roof portion to said positioning portion; said roof portion abutting upon a sealing space having an entrance to be covered with a bottom cover; said bottom cover being provided with a protruding portion on a lateral face thereof to be sleeve-jointed with said through hole; and said protruding portion having a positioning portion for connectively combining with said connecting portions;
whereby it is possible to mount or dismount said ornament containing liquid and floating article on or from said main body of mouse.

2. The computer mouse according to claim 1, in which the surface of said inner casing is printed or stuck with various patterns.

3. The computer mouse according to claim 1, in which said ornament is made of a transparent plastic material.

4. The computer mouse according to claim 1, in which said liquid is a liquid of single species.

5. The computer mouse according to claim 1, in which said liquid is a liquid of two species indissoluble to each other.

6. The computer mouse according to claim 1, in which said floating article is configured in three-dimensional different patterns.
